(19) United States
(12) Patent Application Publication
(10) Pub. No.: US 2005/0103813 A1
(43) Pub. Date: May 19, 2005

(54) Adjustable dual strap design for lifting and carrying awkward or heavy loads

(76) Inventor: Brian Edwards, Wilmington, NC (US)

Correspondence Address: Michael E. Mauney;Attorney at Law, Post Office Box 10266, Southport, NC, 28461, US

(21) Appl. No.: 10/712,972

(22) Filed: Nov. 13, 2003

(51) Int. Cl. A61G 1/00; A45F 3/00; A61G 5/00

(52) U.S. Cl. 224/157

(57) ABSTRACT

A dual strap load carrying apparatus. The first strap has two shoulder loops with a length extending between the first and second shoulder loops. The first strap attaches to a second strap which also has shoulder loops. An object to be carried is positioned on the straps above the point where the two straps connect to each other. The straps will ordinarily extend around the sides of objects to be carried and are secured on the shoulders of two users, who then have their hands free to steady the object while the weight of the object is borne on the shoulders through the shoulder straps. Bulky or odd-shaped loads are easily carried using the dual strap load carrying apparatus.

### FIELD OF THE INVENTION

This invention relates generally to straps designed to facilitate carrying heavy loads by two people. More particularly, this relates to an adjustable two strap apparatus that securely attaches one strap to a second strap to form a device on which a heavy object may be disposed while having two carrying loops on each strap. Ordinarily, the carrying loops will be disposed around the shoulders of a user.

### DESCRIPTION OF RELATED ART

A variety of technologies have been employed to move heavy objects. For example, a wheel is frequently used in some fashion to facilitate moving a heavy object. For example, a dolly is a generally square or rectangular shaped apparatus with multi-directional wheels or casters disposed at each corner. An object is placed on the frame of the dolly, then maneuvered using the multi-directional wheels in the direction the user wants the heavy object to go. A hand truck is a different type of wheeled apparatus that is used to move heavy objects. Usually, there are two wheels disposed on an axle with a plate extending from the axle. A heavy object is positioned on the plate and tilted back onto a framework extending above the two wheels. Sometimes a strap is disposed around the object to attach it to the frame of the hand truck. Leverage is used to pick the object off the ground where its weight rests on the axle and the two wheels and can be rolled into place by the user. Obvious drawbacks with either the dolly or hand truck apparatus are the wheels, which can scratch or mark floors. This is especially a problem in home use and in new construction but less of a problem in industrial applications like a factory or warehouse. Various straps have been proposed for carrying heavy or awkwardly shaped objects. For example, Lyons Jr., U.S. Pat. Nos. 5,927,781 and 5,833,292, disclose a strap arrangement apparently for carrying a large rectangular object like a mattress. In the Lyons applications, two straps are buckled together and extend around the corners of an apparatus. The corner straps are adjustable in size to adjust to relatively thicker objects. In one embodiment, the straps hook around a corner of the object and are secured on the corner with the carrying strap being disposed on the opposite side of the object from the portions of the strap that are secured on the corners of the object. Generally similar devices are seen in Dewey, U.S. Pat. No. 5,503,448 and in Staats, U.S. Pat. No. 5,102,178. Lopreciato, U.S. Pat. No. 6,039,376 discloses a forearm strap for use with furniture. As with the Lyons straps, the Lopreciato straps extend under an object and are held into place by corners of the object. An object is disposed on a strap or straps that extend underneath the object with loops outside of the object on a forearm of a user to help facilitate carrying the object disposed on the straps.

### SUMMARY OF THE INVENTION

Despite this earlier work there is still a need for a strap device to carry large, unwieldy or irregularly shaped objects. It is an object of this invention to allow users to lift the object completely off the surface over which it is carried to avoid marking the floor, unlike a dolly or a hand truck. It is a further object of this invention to have straps that fit over and secure to a user's shoulders to provide maximum leverage for a user to avoid injury to a low back. It is a further object of this invention to easily and readily adjust to different sizes and different shapes of objects and to be useable with objects of uneven or irregular shapes or even a spherical object which has no corners. It is an object of this invention to allow a user to keep his hands free to steady or hold an object while the weight of the object is resting on a user's shoulders.

This invention consists of two straps. The first strap is a single strap with a carrying loop disposed at each end of the strap. The carrying loops are sized and shaped in a fashion to fit over a user's shoulders and may be padded in order to broadly distribute a heavy load more comfortably on a user's shoulders. The second strap consists of a first section, which has a variety of adjusting loops spaced thereon with the loops sized for receipt of the first strap. At one end of this first section, two other sections are formed into a forked or “Y” shape. These sections terminate into carrying loops, again sized for use of shoulders. When in use, one end of the first strap is threaded through an appropriate adjusting loop on the second strap with the two carrying loops on the first strap being equidistant from the adjusting loop on the second strap. An object is then placed on the first piece of the second strap. The two ends of the first strap extend outward from the adjusting loop and around the object to be carried. The forked sections of the second strap also extend outward and around the object to be carried. Users secure the carrying loops on both the first strap and the second strap through their shoulders. One user will be disposed on the side of the carrying loops on the first strap and will secure those carrying loops around his or her shoulders. The second user will secure the carrying loops on the second strap around his shoulders with the object there between. The object will be supported on the first and second straps and balanced between the carrying loops that extend from the bottom of the object to the user's shoulders.

This invention requires no buckles or adjusting of the lengths of the straps, but simply picking the appropriate adjusting loop through which to attach the first strap to the second strap. It requires no corners on an object to secure the straps in place and can carry a spherical or oblong or irregularly shaped object as easily as a rectangular object like a stove or refrigerator. It is easy to use, convenient to manufacture, safe for the users, saves time for those required to carry a heavy load, reduces the risk of injury to users and to the floors over which the load is being carried and allows users free use of their hands.

### BRIEF DESCRIPTION OF THE DRAWINGS

FIGS. 1A and 1B shows the adjustable dual strap invention.

FIG. 2 shows the adjustable dual strap invention connected and seen from above.

FIG. 3 and FIG. 3A shows the adjustable dual strap invention with an egg-shaped object to be carried by the invention shown in place and ready to be lifted by individuals using the shoulder straps.

FIG. 4 shows the adjustable dual strap invention carrying a cylinder or pipe-like object.

### DETAILED DESCRIPTION OF THE DRAWINGS

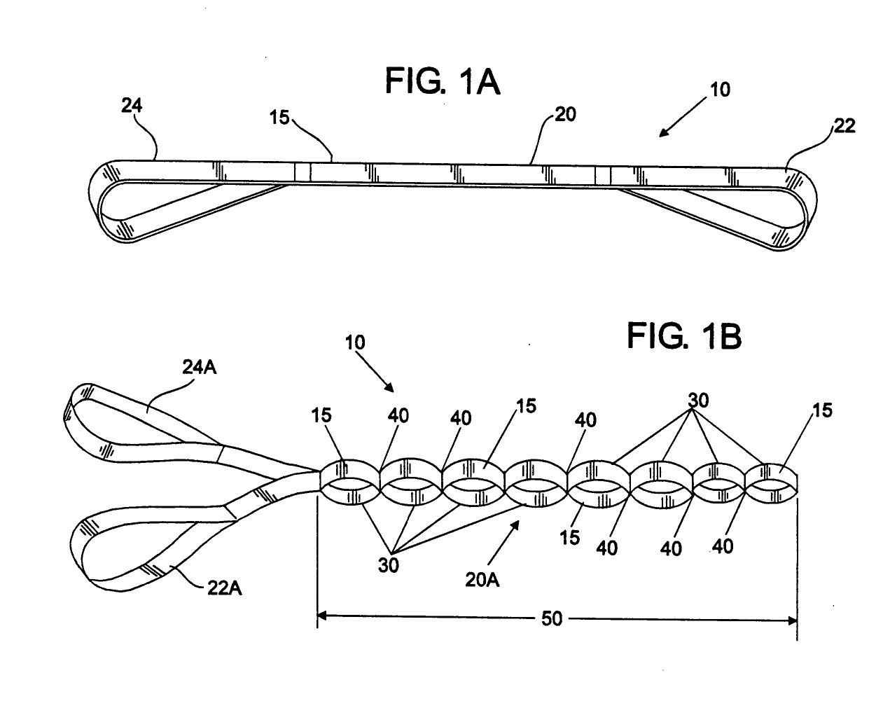

FIG. 1A and FIG. 1B shows the adjustable dual strap carrying invention (10). FIG. 1A shows the flat strap (20). A woven flexible fabric belt (15) is the main portion of the flat strap (20). The flat strap (20) is simply constructed by taking the woven strap (15) and folding a first carrying loop (22) and a second carrying loop (24) then attaching the end of the woven strap (15) to a portion of itself to form respectively the first and second carrying loops (22) and (24). The woven strap (15) may be made of any appropriate material of an appropriate size. Ordinarily, it will be at least an inch in width and made of a durable strong material. Among other materials that could serve are materials that are used in ropes, such as cotton, nylon, or rayon. The materials may be treated appropriately so that they will be durable, less likely to tear or to be cut, will be resistant to weathering, damage from sunlight, and the like. It is only sufficient that the straps be sufficiently wide, sufficiently strong, and sufficiently inelastic to appropriately serve as support for a large, unwieldy, or heavy object. As will be shown in later figures, the first carrying loop (22) and the second carrying loop (24) will ordinarily fit over at least one shoulder of a single user. The “Y” strap (20A) is shown in FIG. 1B. The “Y” strap (20A) is also constructed of the woven strap (15). Again, it is only necessary that one length of woven strap (15) be used to construct the “Y” strap (20A). The woven strap (15) will have a doubled over length (50). It will be attached to itself at at least one and usually more than one place by sewing or other appropriate means of attachment. At the loop connector points (40) the doubled over woven strap (15) will form adjusting loops (30), with an adjusting loop (30) being defined by the point between where the woven strap (15) is doubled over onto itself and attached at the loop connector points (40). The use of the adjusting loops (30) will be shown in later drawings. As with the flat strap (20), for the “Y” strap (20A) the two ends of the woven strap (15) are doubled back on themselves and are attached to form first and second carrying loops (22A) and (24A), which, when in use, will fit over at least one shoulder of an individual user.

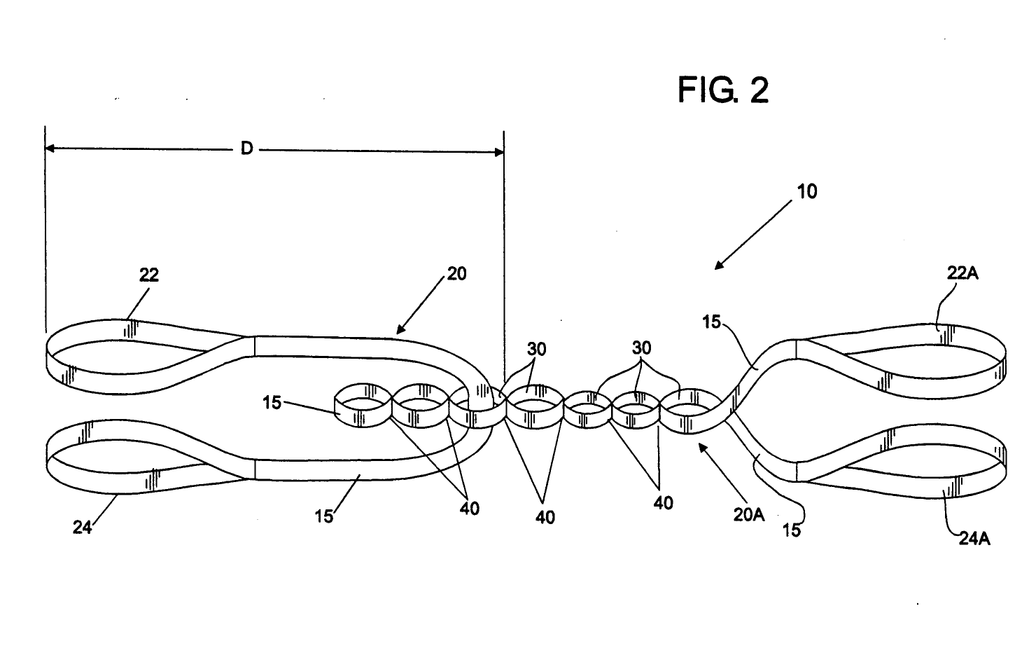

FIG. 2 shows the adjustable dual strap carrying invention (10) in preparation for use. A plurality of adjusting loops (30) are defined by the loop connector points (40). One end of the flat strap (20) is inserted into a suitable adjusting loop (30) on the “Y” strap (20A) The woven strap (15) of the flat strap (20) is now disposed between the two sides of the adjusting loop (30) on the “Y” strap (20A). The flat strap (20) is now securely attached to the “Y” strap (20A) through this adjusting loop (30). It is obvious that the flat strap (20) could be attached to the “Y” strap (20A) using any of the adjusting loops (30) that appear throughout the length of the doubled over portion (50) (seen in FIG. 1B) of the “Y” strap (20A). This allows the use of the adjustable dual strap carrying invention (10) to adjust to objects that may come in a variety of sizes and shapes. Ordinarily, the flat strap (20) will be adjusted so that when it is passed through an adjusting loop (30), the adjusting loop (30) will approximately bisect the length of the flat strap (20). This is shown in FIG. 2 by the first carrying loop (22) and the second carrying loop (24) which are both the distance (D) from the adjusting loop (30) through which the flat strap (20) is passed.

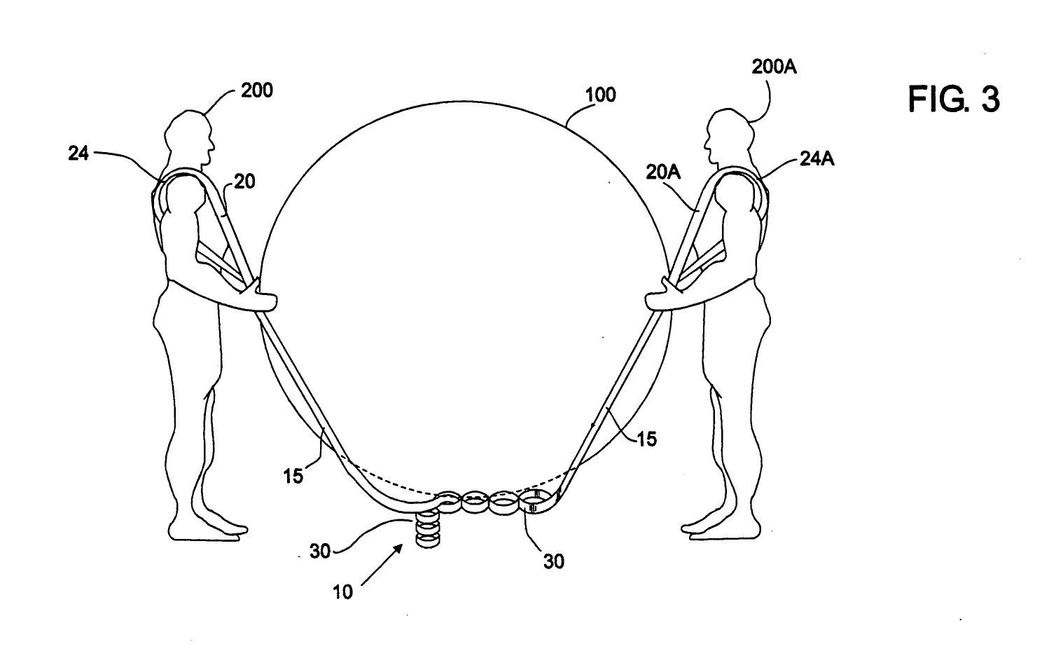

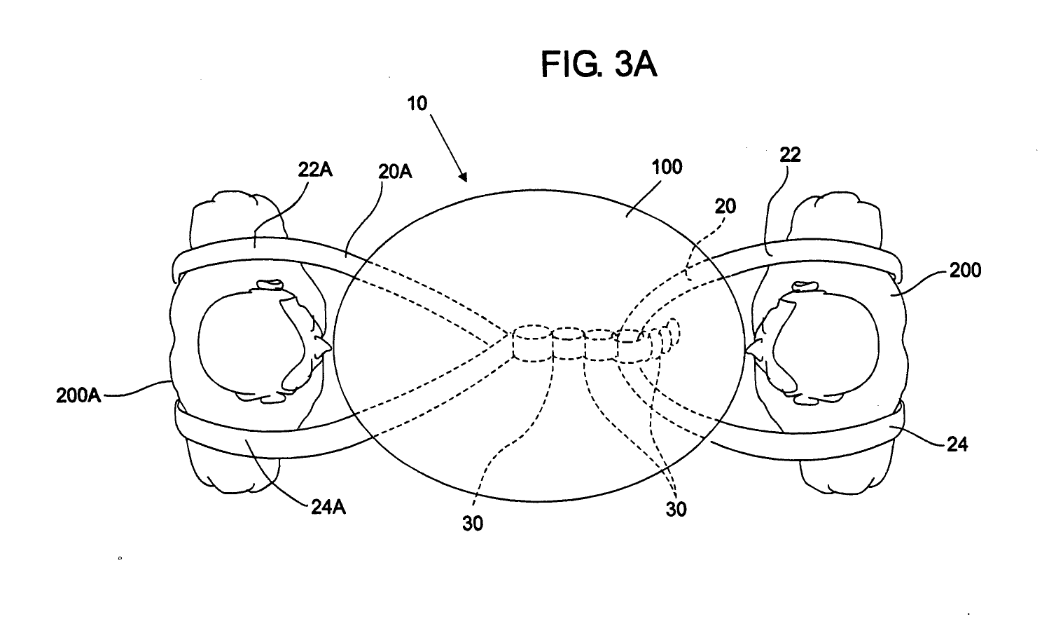

FIG. 3 shows the adjustable dual strap carrying invention (10) in place over the shoulders of a user carrying a large egg-shaped object (100). An egg-shaped object (100) is chosen because of the difficulty this object would pose for many conventional carrying strap systems. It has no corners to which straps or other carrying devices could be secured. Moreover, no end or portion of the egg-shaped object (100) would readily pass within any loop of the strap itself, as is done by some other devices. Many devices used for carrying objects require a portion of the object to be carried to pass within or to be held within a loop within the carrying strap itself. That is not true for the dual strap carrying invention (10). Here, the flat strap (20) is shown on one side extending along the side of the egg-shaped object (100) to an adjusting loop (30) on the “Y” strap (20A). Here the flat strap (20) is shown going through the fourth adjusting loop (30). Unseen in this view are the remaining portions of the flat strap (20) terminating in the first carrying loop (22). The second carrying loop (24) is around the shoulder of the user (200) and it will be understood that the first carrying loop (22) is around the opposite shoulder of the user (200) but unseen in this view. Likewise, the second carrying loop (24A) is seen around one shoulder of the other user (200A) while the remaining first carrying loop (22A) of the “Y” strap (20A) is not seen in this view. The woven strap (15), from both the flat strap (20) and the “Y” strap (20A), extend around each side of the egg-shaped object (100). The weight of the egg-shaped object (100) provides a tension to both the flat strap (20) and the “Y” strap (20A), which keeps the dual strap carrying invention (10) in place against the object.

FIG. 3A is a view from above from what is seen in FIG. 3. Here, the use of the flat strap (20) with the “Y” strap (20A), in effect, forms a generally H-shaped cradle where arms of the “Y” strap (20A) and the flat straps (20) extend up sides of the egg-shaped object (100). In this view, the connection of the flat strap (20) to the “Y” strap (20A) through the adjusting loop (30) is more clearly seen than in FIG. 3. Also, the use of the carrying loops (22, 24, 22A, 24A) around the shoulders of a user (200, 200A) is more clearly shown. When carried using the adjustable dual strap carrying invention (10), it is difficult for the egg-shaped object (100) to move or to shift. The weight and the tension automatically pull the flat strap (20) and the “Y” strap (20A) into place around the sides of the egg-shaped object (100) to secure it in place. The object (100) will have difficulty shifting or moving because of the configuration of the adjustable dual strap carrying invention (10). Moreover, it leaves the arms of the users (200, 200A) free to hold or steady the object in place when being carried.

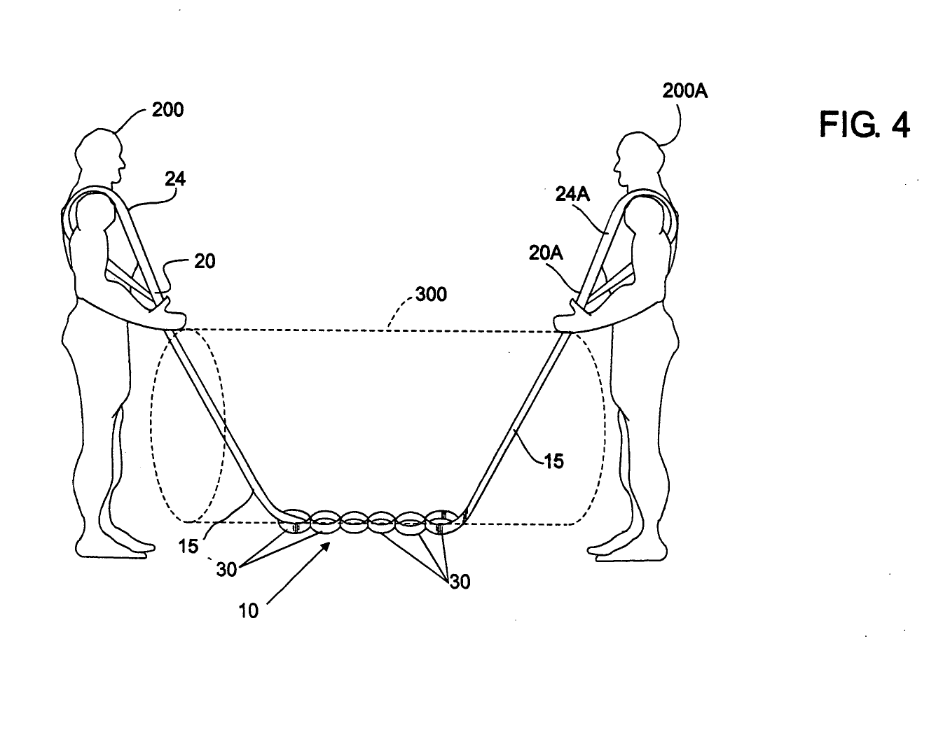

FIG. 4 shows the adjustable dual strap carrying invention (10) in use around a cylinder or pipe-like shape (300). The purpose of showing it in this view is to show how the dual strap carrying invention (10) easily adjusts to the elongated, odd-shaped, pipe-like shape (300), which has no corners or other readily useable shape to allow a carrying strap to be utilized to carry the pipe-like shape (300). Here, the pipe-like shape (300) has a substantial length, as is often the case with a pipe or a roll of carpet. Here, the flat strap (20) is passed through the last adjusting loop (30) on the “Y” strap (20A). The second carrying loop (24) is shown around the shoulder of a user (200). The first carrying loop (22) (not shown) passes around the other shoulder of the user (200). The flat strap (20) surrounds and secures the pipe-like shape (300) from lateral motion. At the opposite end of the pipe-like shape (300) from the user (200) is a second user (200A). Here, the “Y” strap (20A) is secured by the second carrying loop (24A) to the shoulder of the user (200A). The first carrying loop (22A) (not shown) is around the opposite shoulder of the user (200A) and the “Y” strap (20A) extends from the first carrying loop (22A) along a side of the pipe-like shape (300) (not seen in this view). Thus, the “Y” strap (20A) wraps around both sides of the pipe-like shape (300). Likewise, for the user (200), the flat strap (20) extends from one shoulder and the second carrying loop (24) around the side of the pipe-like shape (300) through the last adjusting loop (30) on the “Y” strap (20A) up and along the opposite side of the pipe-like shape (300) to the first carrying loop (22) on the other shoulder of the user (200). Thus, the dual strap carrying invention (10) forms a cradle in which the large, lengthy, unwieldy pipe-like shape (300) may be secured. The adjusting loops (30) and the doubled over portion (50) of the “Y” strap (20A) rests on the bottom side of the pipe-like device (300) and is used to support it. The two portions of the flap strap (20) that extend around opposite sides of the pipe-like shape (300) reduce any lateral motion of the pipe-like shape (300) as does the two arms of the “Y” strap (20A), which extend around the sides of the pipe-like shape (300) and are secured on opposite shoulders of the user (200A). Because the weight of the pipe-like shape (300) is supported on the carrying loops (22, 24, 22A, 24A), the user's (200, 200A) hands may be used to steady and secure the pipe-like shape (300) in the dual strap carrying invention (10).

It is readily seen in FIGS. 3, 3A, and 4 how the dual strap carrying invention (10) adjusts to different sizes and shapes of items to be carried, while allowing a user to easily and securely carry the device. The weight of the object carried by the dual strap carrying invention (10) both secures it in place and secures it against lateral movement. If properly used, the dual strap carrying invention (10) may be used to carry small heavy items, large heavy items, or large unwieldy items, which may not have great weight. It readily and easily adopts to objects having a wide variety of shapes and configurations, including those with corners such as household appliances, like stoves or refrigerators, while also adapts odd-shaped devices, like pipes, tanks, carpet rolls or other items which may not have corners or any other shape which allows them to be readily secured within the straps.

1. A load carrying apparatus comprising:
(a) a first strap, said first strap having at a first end of said first strap, a first strap first loop, and at a second end of said first strap, a first strap second loop; and a first strap mid-length of said first strap between said first strap first loop and said first strap second loop;
(b) a second strap, said second strap having at a first end of said second strap, a second strap first loop, and at a second end of said second strap, a second strap second loop; and a second strap mid-length of said second strap between said second strap first loop and said second strap second loop;
(c) means for adjustably attaching said first strap mid-length to said second strap mid-length;
whereby a load to be carried is positioned on said first strap mid-length strap and said second strap mid-length after said first strap mid-length is attached to said second strap mid-length by said means for attaching, with said first strap first loop and said first strap second loop used by a first user and said second strap first loop and said second strap second loop used by a second user, first user and second user using said first and second straps to carry a load.

2. A load carrying apparatus of claim 1 wherein said second strap is formed in a Y shape with a first arm of a Y shape and a second arm of a Y shape intersecting to form a body of said Y shape, said body extending from said place of intersection and forming said second strap mid-length, with said second strap first loop formed in said first arm of said Y shape and said second strap second loop formed in said second arm of said Y shape.

3. A load carrying apparatus of claim 2 wherein said means for adjustably attaching said first strap mid-length to said second strap mid-length is positioned on said second strap mid-length of said second strap.

4. A load carrying apparatus of claim 3 wherein said means for attaching is a plurality of attaching loops formed in said second strap mid-length, said attaching loops of a definite size for receipt of an end of said first strap through at least one of said plurality of attaching loops.

5. A dual strap load carrying apparatus comprising:
(a) a first strap, said first strap having a first and second shoulder loop whereby a first user may secure said first strap onto a first user's shoulder using said first strap's said first shoulder loop and said first strap's second shoulder loop;
(b) a second strap, said second strap having a first and a second shoulder loop whereby a second user may secure said second strap on a second user's shoulders using said second strap first shoulder loop and said second strap second shoulder loop;
(c) on said second strap a plurality of connecting loops whereby said first strap may pass through at least one of said connecting loops thereby forming a cradle for objects to be carried by a first user using said first strap first shoulder loop and said first strap second shoulder loop and a user using said second strap first shoulder loop and said second strap second shoulder loop with an object positioned between first user and second user and supported by said first strap and by said second strap which are connected through said at least one connecting loop.

6. A dual strap load carrying apparatus of claim 5 wherein said second strap is formed into a Y shape.

7. A dual strap load carrying apparatus of claim 6 wherein said second strap first shoulder loop is formed in a first arm of the Y shape, said second shoulder strap second loop is formed in a second arm of said Y shape and said attaching loops are formed on said second strap distal to where said first arm and said second arm intersect.
